(19) United States
(12) Patent Application Publication
(10) Pub. No.: US 2009/0235166 A1
(43) Pub. Date: Sep. 17, 2009

(54) Presentation Summary Slide Thumbnails

(75) Inventors: Susann Keohane, Austin, TX (US); Johnny Meng-Han Shieh, Austin, TX (US); Shawn Mullen, Buda, TX (US); Gerald F. McBrearty, Austin, TX (US); Jessica C. Murillo, Round Rock, TX (US)

Correspondence Address: Cahn & Samuels, LLP, 1100 17th St., NW, Ste. 401, Washington, DC, 20036, US

(73) Assignee: INTERNATIONAL BUSINESS MACHINES CORPORATION, Armonk, NY (US)

(21) Appl. No.: 12/050,036

(22) Filed: Mar. 17, 2008

(51) Int. Cl. G06F 3/14

(52) U.S. Cl. 715/273

(57) ABSTRACT

A system and method for presenting individual slides of a presentation on one composite slide wherein the composite slide may be integrated within the presentation. Each individual slide is represented as a thumbnail view on the composite slide and is capable of launching the full version of the presentation by directly linking to the individual slide represented by the thumbnail. The system and method eliminates the need to scroll through each slide of the presentation to find a slide of interest. The system and method also allows the presentation slides to be rearranged or grouped in the composite slide without affecting the order of the individual slide in the presentation.

### I. FIELD OF THE INVENTION

This invention relates to a multimedia application that organizes various slides of a presentation as thumbnails that may be viewed and used to quickly access the full version of the presentation without the need to scroll through the slides individually.

### II. BACKGROUND OF THE INVENTION

When making presentations or giving discussions, presenters often utilize electronic slides that include textual and/or graphic information as a visual aid to both the presenter and the audience. These slides are generally scrolled through in a sequential fashion over the course of the presentation. Once the presentation is complete, it is common for the presenter to answer any questions from the audience. These questions are typically related to the presentation and are often directed towards specific slides.

When answering questions related to specific slides, the presenter—often at the request of the audience—attempts to locate the specific slide. In order to locate the slide, the presenter must scroll through the various slides in an effort to find the particular slide related to the question. Depending on the number and complexity of the slides this can be a difficult and time consuming task.

Some current applications offer some means of sorting slides as thumbnail view. Clicking on a chart thumbnail takes the presenter to the full version of the presentation. However, these current applications do not provide a means for incorporating this view into a chart within the presentation, particularly a chart that allows the thumbnail slides to link directly to the selected slide as opposed to the full version of the presentation. It would be beneficial to both the presenter and the audience to have a thumbnail view of presentation slides as a thumbnail view of the slides would provide a quick and useful visual aid to the both the presenter and the audience.

Notwithstanding the usefulness of the above-described methods, a need still exists for a presentation application that allows presentation slides to be viewed as thumbnails on a slide within the presentation. A need also exists for a presentation application that allows presentation slides to be rearranged and grouped within a thumbnail view on a slide within the presentation without affecting the order in which the slides are presented.

### Ill. SUMMARY OF THE INVENTION

In at least one exemplary embodiment the present invention provides a method for integrating and displaying slides in a presentation, including: receiving two or more slides of information, wherein said slides are organized as a presentation; displaying said two or more slides as thumbnail views; organizing said thumbnail views onto a composite slide containing at least two of said slides, wherein organizing said thumbnail views does not affect the order in which said slides are presented in the presentation; and inserting said composite slide into said presentation, wherein each of said thumbnail views allows the full version of the slide to be directly accessed by clicking on the particular thumbnail view of the presentation.

An objective of the present invention is to provide a means for organizing thumbnail view of multiple individual slides of a presentation into a composite slide that may itself be integrated into the presentation.

Another objective of the present invention is to provide a means for launching the full version of the multiple individual slides by clicking on the thumbnail views of the slide.

Another objective of the present invention is to provide a means for reorganizing or reordering the thumbnail views of the individual slides within the composite slide without affecting the order to the individual slides within the presentation.

An advantage of the present invention is that it provides a means for more efficiently and effectively making and organizing presentations.

Another advantage of the present invention is that it provides a means for more effectively organizing the individual slides of a presentation into a composite slide capable of directly launching the individual slides without reordering the slides within the presentation.

### IV. BRIEF DESCRIPTION OF THE DRAWING

The present invention is described with reference to the accompanying drawings, wherein:

FIG. 1 illustrates a composite presentation slide that incorporates individual presentation slides in accordance with an exemplary embodiment of the present invention.

FIG. 2 illustrates another composite presentation slide that incorporates various groups of individual presentation slides in accordance with an exemplary embodiment of the present invention.

Given the following enabling description of the drawings, the apparatus should become evident to a person of ordinary skill in the art.

### V. DETAILED DESCRIPTION OF THE DRAWINGS

The present invention in at least one exemplary embodiment provides a system and method that presents the individual slides of a presentation on one composite slide. The composite slide may be integrated within the presentation wherein each thumbnail from the composite slide is capable of launching the full version of the presentation. The thumbnails also directly link to the individual slide represented by the thumbnail thereby eliminating the need to scroll through each slide of the presentation to find a slide of interest. While the individual slides are referred to herein as thumbnails other views such as tiles, icons, or similar representations may be utilized without departing from the invention.

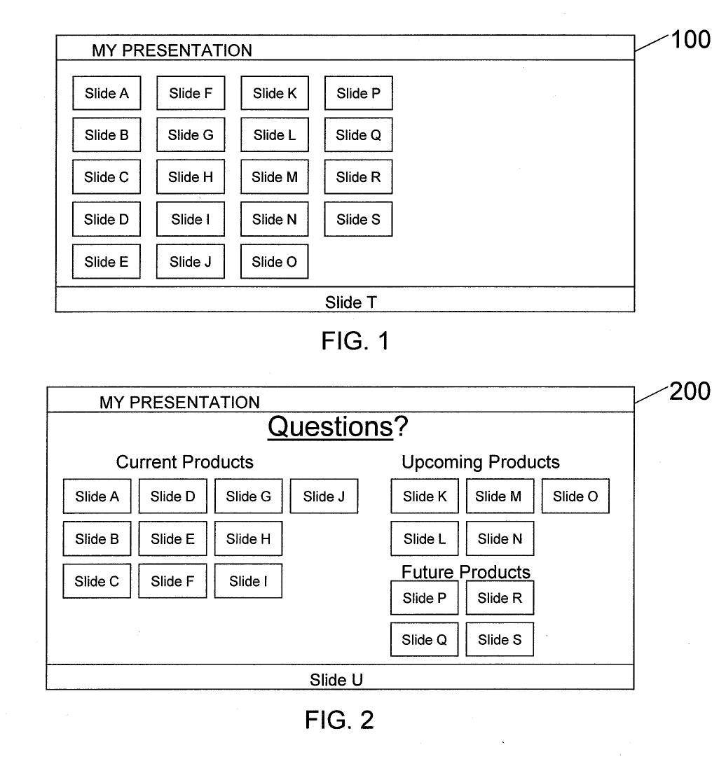

As illustrated in FIG. 1, the present invention provides a system that allows individual presentation slides A-S to be presented in thumbnail views (thumbnails A-S) in one composite slide 100. Thumbnails A-S provide a direct link to the full version of the slides that they represent. By clicking on a particular thumbnail A-S a user is taken to the full (active) version of that slide. Composite slide 100 may also be incorporated into the presentation as a slide or thumbnail T. The present invention enables all slides A-S to be viewed in one composite slide 100. The composite slide 100 enables users to present multiple thumbnails in one view and quickly and efficiently locate and launch the slide of interest.

As illustrated in FIG. 2, the present invention also enables thumbnails A-S of the composite slide 200 to be reorganized or reordered. Thumbnails A-S may be organized into groups, as shown in FIG. 2. Thumbnails A-S may, for example, be organized into groups related to a particular topic. In FIG. 2, slide U outlines and organizes “Questions?”, for example, that might be appropriate for discussion at the end of a presentation. Composite slide U list thumbnails A-J under the heading “CurrentProducts”, thumbnails K-O under the heading “Upcoming Products”, and thumbnails P-S under the heading “Future Products”. This organization provides an instructive tool related to the content of the presentation and the individual slides A-S to the presenter and the audience.

Thumbnails A-S may also be renumbered or listed in the composite slide U in any preferred or random order. Reorganizing or reordering the slides A-S in the composite slide 200 can be performed without affecting the order of the individual slides A-S within the presentation 200. As discussed with respect to FIG. 1, these thumbnails A-S also provide a direct link to the full version of the slides that they represent. Clicking on a particular thumbnail A-S links to the full (active) version of that slide. This organization or reorganization of slides A-S provides a more effect and efficient means of making a presentation.

The invention can take the form of an entirely hardware embodiment, an entirely software embodiment or an embodiment containing both hardware and software elements. In at least one exemplary embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As will be appreciated by one of ordinary skill in the art, the present invention may be embodied as a computer implemented method, a programmed computer, a data processing system, a signal, and/or computer program. Accordingly, the present invention may take the form of an entirely hardware embodiment, an entirely software embodiment or an embodiment combining software and hardware aspects. Furthermore, the present invention may take the form of a computer program on a computer-usable storage medium having computer-usable program code embodied in the medium. Any suitable computer readable medium may be utilized including hard disks, CD-ROMs, optical storage devices, carrier signals/waves, or other storage devices.

The exemplary embodiments described above may be combined in a variety of ways with each other. Furthermore, the steps and number of the various steps illustrated in the figures may be adjusted from that shown.

Although the present invention has been described in terms of particular exemplary embodiments, it is not limited to those embodiments. Alternative embodiments, examples, and modifications which would still be encompassed by the invention may be made by those skilled in the art, particularly in light of the foregoing teachings.

Those skilled in the art will appreciate that various adaptations and modifications of the exemplary embodiments described above can be configured without departing from the scope and spirit of the invention. Therefore, it is to be understood that, within the scope of the appended claims, the invention may be practiced other than as specifically described herein.

1. A method for integrating and displaying slides in a presentation, comprising:
receiving two or more slides of information, wherein said slides are organized as a presentation;
displaying said two or more slides as thumbnail views;
organizing said thumbnail views onto a composite slide containing at least two of said slides, wherein organizing said thumbnail views does not affect the order in which said slides are presented in the presentation;
reorganizing said thumbnail views onto said composite slide, wherein reorganizing said thumbnail views does not affect the order in which said slides are presented in the presentation; and
inserting said composite slide into said presentation, wherein each of said thumbnail views allows the full version of said two or more slides to be directly accessed by clicking on the particular thumbnail view of the presentation.
